(19) United States
(12) Patent Application Publication
(10) Pub. No.: US 2012/0152450 A1
(43) Pub. Date: Jun. 21, 2012

(54) Wood panel coating method

(75) Inventors: Jae-Chul JIN, Gyeonggi-do (KR); Ho-Suk RHYU, Gyeonggi-do (KR); Ah-Hyun BAE, Gyeonggi-do (KR); Jin-Tack SHIN, Gyeonggi-do (KR); Ki-Yul LIM, Gyeonggi-do (KR)

(73) Assignee: Samsung Electronics Co., LTD., Gyeonggi-do (KR)

(21) Appl. No.: 13/374,313

(22) Filed: Dec. 21, 2011

(30) Foreign Application Priority Data
Dec. 21, 2010 (KR) 10-2010-0131958

(51) Int. Cl. B05D 3/12

(52) U.S. Cl. 156/245; 427/325; 427/289

(57) ABSTRACT

The present disclosure relates to a wood panel coating method for coating a wood panel hot-pressed and shaped into a curved shape. The wood panel coating method includes: hot-pressing a wood panel with a press machine to shape the wood into a curved shape; coating primer for a base coat on a surface of the wood panel; curing the primer coated on the surface of the wood panel; and coating intermediate top coats on the surface of wood panel.

### CLAIM OF PRIORITY

This application claims the priority under 35 U.S.C. §119 of an application entitled “Wood Panel Coating Method” filed in the Korean Intellectual Property Office on Dec. 21, 2010 and assigned Serial No. 10-2010-0131958, the contents of which are hereby incorporated by reference.

### BACKGROUND OF THE INVENTION

1. Field of the Invention

The present invention relates to a wood panel coating method, and more particularly to a wood panel coating method which hot-presses and shapes a wood panel into a curved shape.

2. Description of the Related Art

In general, a wood-based wood panel, such as plywood, medium density fiberboard, and hardboard, as well as a wood panel formed of various materials and coated can provide an elegant exterior surface or a specific pattern while protecting the surface.

As shown in FIGS. 1 and 2, a conventional wood panel coating method includes: sanding a surface of a wood panel to smoothen the surface; shaping the wood panel into a curved shape; coating primer (coating material for a base coat) 4 using a roll coater 2, a flow coater and a spray coater; conducting pore-filling for filling holes and recesses (those formed, e.g. by the texture of the wood panel) on the surface of the wood panel with the primer by pressing the primer coated on the surface of the wood panel with a reverse roll coater 3 in a state in which the primer is wet, so that the primer is pushed into and fills the holes and recesses; curing the primer coated on the surface of the wood panel; and coating intermediate and top coats on the surface of the wood panel after the holes and recesses on the surface are filled with the primer.

In addition, as shown in FIGS. 3 and 4, another conventional wood panel coating method includes: sanding a surface of a wood panel to smoothen the surface; coating primer (coating material for base coat) 4 using a roll coater 2, a flow coater and a spray coater; conducting pore-filling for filling holes and recesses (those formed, e.g. by the texture of the wood panel) on the surface of the wood panel with the primer by pressing the primer coated on the surface of the wood panel with a reverse roll coater 3 in a state in which the primer is wet, so that the primer is pushed into and fills the holes and recesses; curing the primer coated on the surface of the wood panel; coating intermediate and top coats on the surface of the wood panel after the holes and recesses on the surface are filled with the primer; and shaping the wood panel into a curved shape.

The pore-filling is conducted by rotating the roll of the reverse roll coater in a state in which the roll is in contact with the surface of the wood panel so that the primer is pushed into holes and recesses formed by the texture of the wood panel.

However, for a curved wood panel, such pore-filling is not suitable, and coating is difficult.

In accordance with the firstly described conventional coating method, primer for a base coat is coated and pore-filling is conducted using respective coaters after shaping the wood panel into a curved shape. However, since the coaters are flat, the central area of the wood panel is well coated, and pore-filling is performed well in the central area, whereas the edge areas of the wood panel are not coated well, and the pore-filling is not conducted well. As a result, it is very difficult to conduct the entire coating of the wood panel in the former prior art.

In accordance with the secondarily described conventional coating method, a wood panel is shaped into a curved shape after primer is coated, pore-filling is conducted, and intermediate and top coats are coated using respective coaters. In such a case, the coating on the surface of the wood panel may be easily fractured and damaged in the later prior art.

Moreover, in accordance with the above-mentioned conventional coating methods, sanding for smoothing the surface of the wood panel must be performed manually, which is difficult to task and time-consuming. In addition, it is necessary to supply primer sufficiently for coating and pore-filling using respective coaters, which increases manufacturing costs.

Accordingly, there is a need to improve workability and productivity in a coating process which can obtain the effects of sanding for smoothing the surface of a wood panel, pore-filling, and shaping the wood panel into a curved shape at one time.

### SUMMARY OF THE INVENTION

Accordingly, the present invention has been made to solve the above-mentioned problems occurring in the prior art, and an aspect of the present invention provides a wood panel coating method which shapes a wood panel into a curved shape and simultaneously hot-pressing the wood panel, so that the steps of sanding for smoothing a wood panel, pore-filling, and shaping the wood panel into a curved shape in a conventional wood coating method can be substituted with a single hot-pressing process, whereby steps for treating a product can be reduced and thus improving workability and productivity of a product.

Another aspect of the present invention provides a wood panel coating method which shapes a wood panel into a curved shape simultaneously with hot-pressing, so that it is not required to separately coat primer for the purpose of pore-filling to fill holes and recesses on a wood panel, whereby coating steps can be reduced and the primer can be saved and thus improving productivity of a product.

In accordance with an aspect of the present invention, a wood panel coating method includes: hot-pressing a wood panel with a press machine to shape the wood into a curved shape; coating primer for a base coat on a surface of the wood panel; curing the primer coated on the surface of the wood panel; and coating intermediate and top coats on the surface of wood panel.

In accordance with another aspect of the present invention, a wood panel coating method includes: hot-pressing a wood panel with a press machine to shape the wood into a curved shape; cutting parts in the outside of the curved parts of the wood panel to form the wood panel in a shape of an electronic device case; insert-molding the wood panel with an electronic device case; coating primer for base coat on a surface of the wood panel; curing the primer coated on the surface of the wood panel; and coating intermediate and top coats on the surface of wood panel.

Further, in accordance with another aspect of the present invention, a wood panel coating method includes: hot-pressing a wood panel with a press machine to shape the wood into a curved shape; cutting parts in the outside of the curved parts of the wood panel to form the wood panel in a shape of an electronic device case; coating primer for a base coat on a surface of the wood panel; curing the primer coated on the surface of the wood panel; coating intermediate and top coats on the surface of wood panel; and attaching the wood panel to an electronic device case with an adhesive means.

### BRIEF DESCRIPTION OF THE DRAWINGS

The patent or application file contains at least one drawing executed in color. Copies of this patent or patent application publication with color drawings will be provided by the U.S. Patent and Trademark Office upon request and payment of the necessary fee.

The above and other aspects, features and advantages of the present invention will be more apparent from the following detailed description taken in conjunction with the accompanying drawings, in which:

FIG. 1 shows a conventional wood panel coating method;

FIG. 2 shows a flowchart of the convention wood panel coating method of FIG. 1;

FIG. 3 shows another conventional panel coating method;

FIG. 4 is a flowchart of the conventional wood panel coating method of FIG. 3;

FIG. 5 is a flowchart of a wood panel coating method in accordance with a first embodiment of the present invention;

FIG. 6 is a flowchart of a wood panel coating method in accordance with a second embodiment of the present invention;

FIG. 7 shows a state before performing hot-pressing in the wood panel coating methods in accordance with first and second embodiments of the present invention;

FIG. 8 shows a state after performing hot-pressing in the wood panel coating methods in accordance with first and second embodiments of the present invention; and

FIG. 9 shows a wood panel obtained after performing hot-pressing in the wood panel coating methods in accordance with first and second embodiments of the present invention.

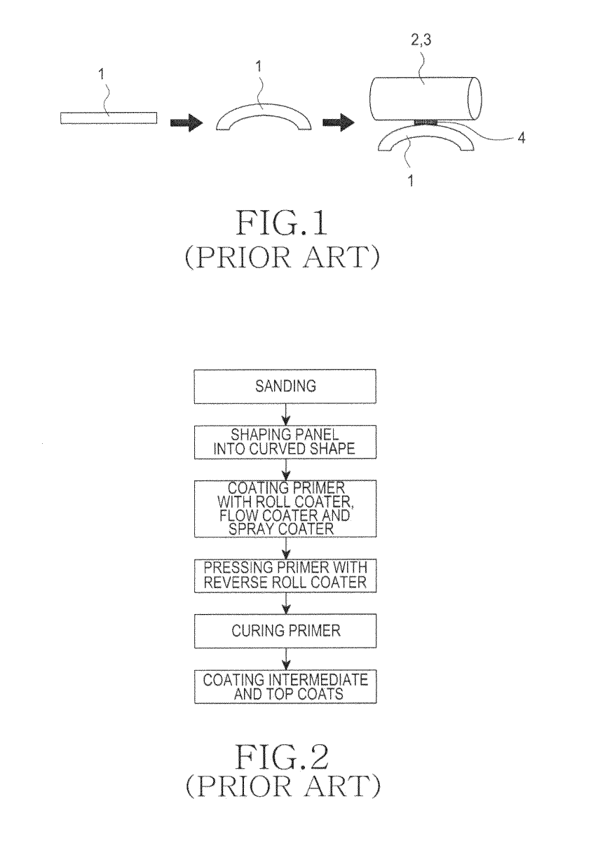

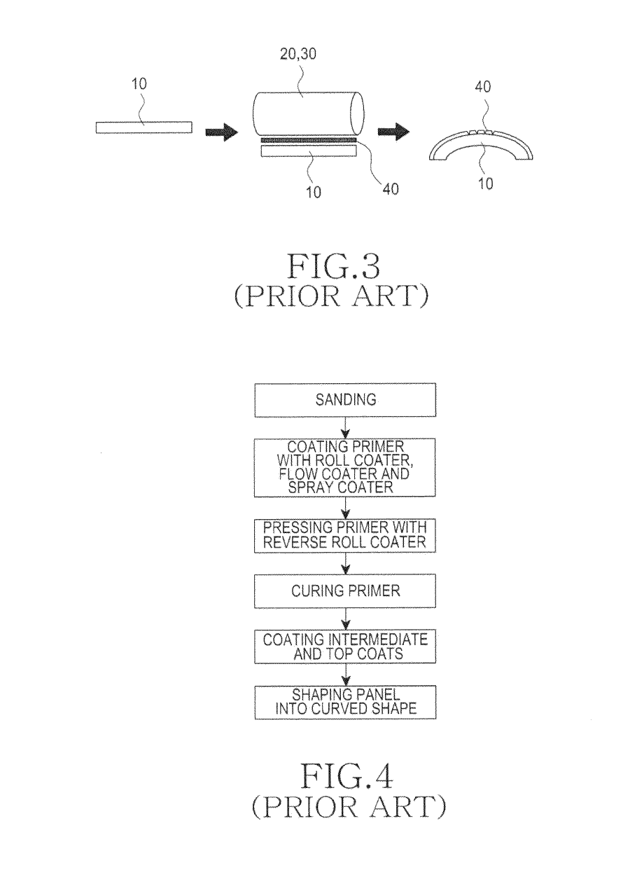

### DETAILED DESCRIPTION OF THE PRESENT INVENTION

Hereinafter, embodiments of the present invention will be described with reference to the accompanying drawings. For the purposes of clarity and simplicity, a detailed description of known functions and configurations incorporated herein will be omitted as it may make the subject matter of the present invention unclear.

Briefly, the inventive wood panel coating method is adapted firstly to put a wood panel 100 in an untreated condition into a press machine 200 to shape the wood panel 100 into a curved shape by hot-pressing the wood panel 100 with the press machine 200.

Thereafter, a surface of the wood panel 100 is coated with primer for a base coat so as to coat the intermediate and top coats.

The primer can be cured on the surface of the wood panel 100.

The surface of the wood panel 100 is adapted to be coated with the intermediate and top coats so as to protect the surface.

The wood panel 100 is adapted to be attached to an object, such as a case of an electronic device (not shown) through insert molding or by an adhesive means. The adhesive means may be a double-sided adhesive tape. Alternatively, another adhesive means, such as bond or silicon, may be employed.

In addition, the inventive wood panel 100 can be applied to a case of an electronic device, as a representative application example. Beyond such an application, the inventive wood panel 100 can be applied to various types of articles, such as inner and outer cases of a portable communication device, a refrigerator case, a TV case, a notebook PC case, and a cosmetic container.

Examples to which the inventive wood panel is applicable include all types of information devices, electronic devices, multimedia devices and the application thereof, such as MP3 player, navigation set, game machine, notebook PC, sign board, TV, digital broadcasting player, personal digital assistant (PDA), and smart phone, as well as the above-mentioned portable communication device which may include all kinds of mobile communication devices operated by communication protocols corresponding to various communication systems.

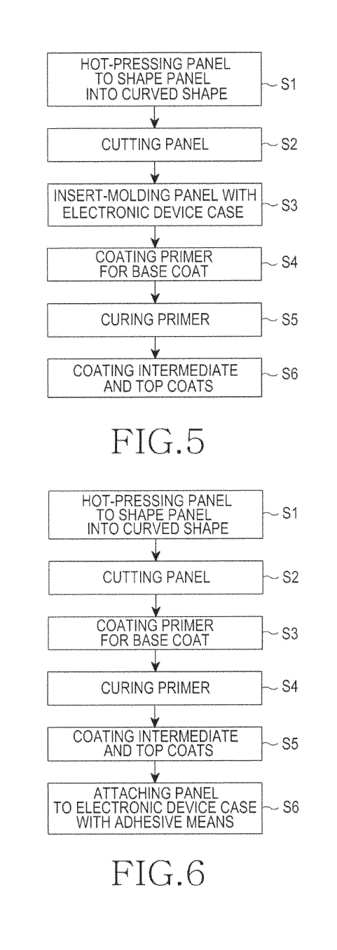

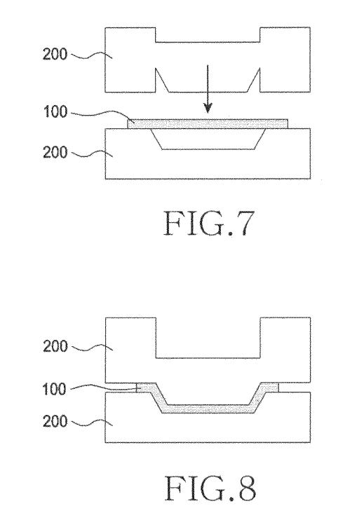

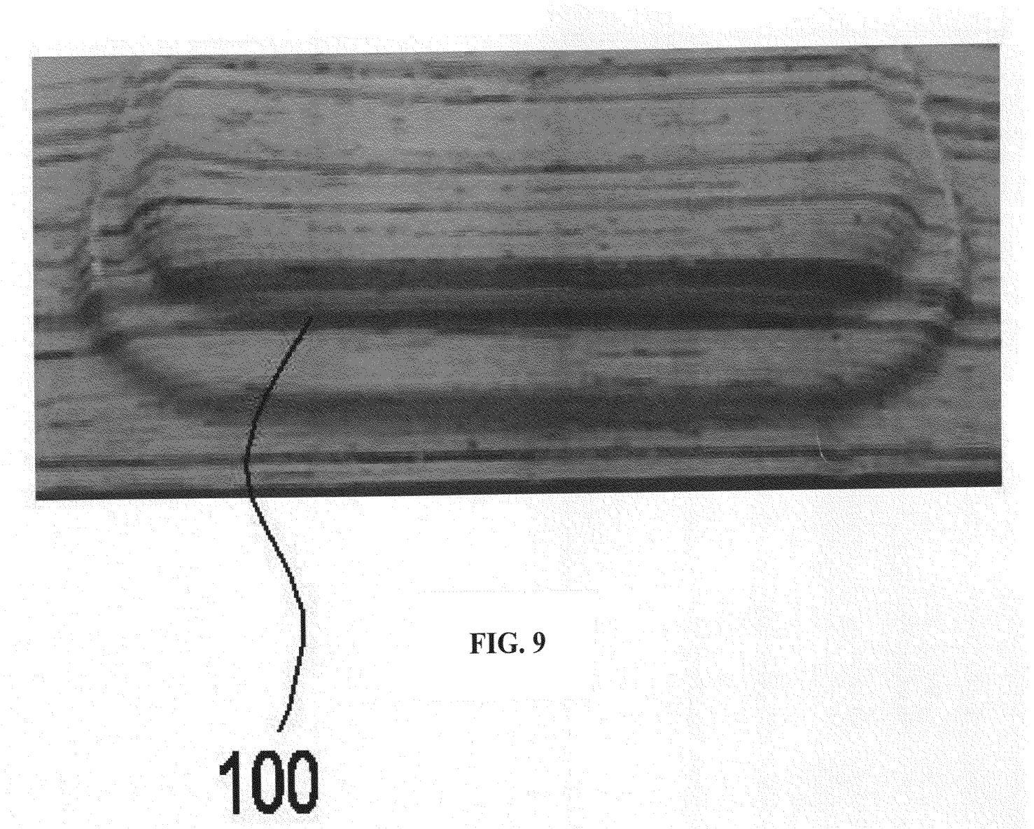

Now, a wood panel coating method in accordance with a first embodiment of the present invention will be described in detail with reference to FIGS. 5 and 7 to 9.

As shown in FIGS. 5 and 7 to 9, the inventive wood panel coating method firstly puts a wood panel 10 in an untreated condition into a press machine 200 and shapes the wood panel into a curved shape by hot-pressing the wood panel 100 with the press machine 200 (S1).

Since the wood panel 100 is shaped into a curved shape through hot-pressing, a surface of the wood panel 100 is smoothened and the tissues of the wood panel are compacted, thus the effects of sanding and shaping processes in the prior art can be obtained at one time in step S1.

After step S1, the outside parts of the curved portions of the wood panel 100 are cut to form a desired shape (for example, a shape of an electronic device case) (S2).

After step S2, the cut wood panel 100 is insert-molded with an electronic device case (not shown) to attach the wood panel 100 to the electronic device case (S3).

After step S3, a primer for base coat is coated on the surface of the wood panel 100 (S4).

Here, since a process for coating primer to fill holes and recesses on the surface of the wood panel 100 is not required as in the prior art, the number of steps for manufacturing a final product can be reduced. Also, since the primer step can be saved, the manufacturing costs of the final product can be reduced.

After step S4, the primer coated on the surface of the wood panel 100 is cured (S5).

After step S5, the surface of the wood panel 100 is coated with intermediate and top coats so as to protect the surface (S6).

Since base, intermediate, and top coats are applied to the surface of the wood panel shaped into a curved shape, the entire surface of the wood panel 100 can be uniformly coated, and the coating prevents from being fractured or damaged. That is, such coating may be fractured or damaged if such a wood panel is shaped into a curved shape after the coated film is formed in the prior art.

Now, a wood panel coating method in accordance with a second embodiment of the present invention will be described in detail with reference to FIGS. 6 and 7 to 9.

As shown in FIGS. 6 and 7 to 9, the inventive wood panel coating method firstly puts a wood panel 10 in an untreated condition into a press machine 200 and shapes the wood panel into a curved shape by hot-pressing the wood panel 100 with the press machine 200 (S1).

Again, since the wood panel 100 is shaped into a curved shape through hot-pressing, a surface of the wood panel 100 is smoothened and the tissues of the wood panel are compacted, whereby the effects of sanding and shaping processes in the prior art can be obtained at one time.

After step S1, the outside parts of the curved portions of the wood panel 100 are cut to form a desired shape (for example, a shape of an electronic device case) (S2).

After step S2, a primer for base coat is coated on the surface of the wood panel 100 (S3).

Here, since a process for coating primer to fill holes and recesses on the surface of the wood panel 100 is not required as in the prior art, the number of steps for manufacturing a final product can be reduced. Further, since the primer can be saved, the manufacturing costs of the final product can be reduced.

After step S3, the primer coated on the surface of the wood panel 100 is cured (S4).

After step S4, the surface of the wood panel 100 is coated with intermediate and top coats so as to protect the surface (S5).

After step S5, the wood panel 100 is attached to an electronic device case with an adhesive means (not shown) (S6).

Since base, intermediate, and top coats are applied to the surface of the wood panel 100 shaped into a curved shape, the entire surface of the wood panel 100 can be uniformly coated, and the coating on the surface serves to prevent the exterior from being fractured or damaged, wherein the coating may be fractured or damaged if such a wood panel is shaped into a curved shape after the coated film is formed as in the prior art.

While the invention has been shown and described with reference to certain embodiments thereof, it will be understood by those skilled in the art that various changes in form and details may be made therein without departing from the spirit and scope of the invention as defined by the appended claims.

What is claimed is:

1. A wood panel coating method comprising:
hot-pressing a wood panel with a press machine to shape the wood into a predetermined curved shape;
providing a primer for a base coat on a surface of the wood panel;
curing the primer coated on the surface of the wood panel to form a desired shape; and
providing intermediate and top coats on the surface of wood panel.

2. The wood panel coating method as claimed in claim 1, wherein the wood panel is coupled to an electronic device case through insert molding or by an adhesive means.

3. The wood panel coating method as claimed in claim 1, wherein the adhesive means comprises a double-sided adhesive tape.

4. The wood panel coating method as claimed in claim 1, wherein the wood panel is in an untreated condition during the hot-pressing.

5. A wood panel coating method comprising:
hot-pressing a wood panel with a press machine to shape the wood into a predetermined curved shape;
cutting outside parts of the curved portions of the wood panel to form the wood panel in a shape of an electronic device case;
insert-molding the wood panel with an electronic device case;
providing a primer for a base coat on a surface of the wood panel;
curing the primer coated on the surface of the wood panel; and
providing intermediate and top coats on the surface of wood panel.

6. The wood panel coating method as claimed in claim 5, wherein the wood panel is in an untreated condition during the hot-pressing.

7. A wood panel coating method comprising:
hot-pressing a wood panel with a press machine to shape the wood into a predetermined curved shape;
cutting outside parts of the curved portions of the wood panel to form the wood panel in a shape of an electronic device case;
providing a primer for a base coat on a surface of the wood panel;
curing the primer coated on the surface of the wood panel to form a desired shape;
providing intermediate coat and top coats on the surface of wood panel; and
coupling the wood panel to an electronic device case with an adhesive means.

8. The wood panel coating method as claimed in claim 7, wherein the adhesive means comprises a double-sided adhesive tape.

9. The wood panel coating method as claimed in claim 7, wherein the wood panel is in an untreated condition during the hot-pressing.
